(19) United States
(12) Patent Application Publication
(10) Pub. No.: US 2005/0107985 A1
(43) Pub. Date: May 19, 2005

(54) Method and apparatus to estimate client perceived response time

(75) Inventors: Dakshi Agrawal, Monsey, NY (US); Lap T. Huynh, Cary, NC (US); David P. Olshefski, Danbury, CT (US); Dinesh Verma, Mt. Kisco, NY (US)

Correspondence Address: DILWORTH & BARRESE, LLP, 333 EARLE OVINGTON BLVD., UNIONDALE, NY, 11553, US

(73) Assignee: International Business Machines Corporation, Armonk, NY (US)

(21) Appl. No.: 10/713,306

(22) Filed: Nov. 14, 2003

(51) Int. Cl. G06F 11/30

(52) U.S. Cl. 702/186

(57) ABSTRACT

A method for estimating a response time by combining metrics from networking and application layers. This is achieved by placing correlation tags in data collected at these layers so that the data can later be identified as corresponding to a single web page download or a web session. Once data corresponding to a single web page download or a web session is identified, a splicing algorithm calculates client perceived response time by using analytical models of response time.

### BACKGROUND OF THE INVENTION

1. Field of the Invention

The present invention relates to the field of performance engineering of a web server, and more specifically to measuring the response time of a web server as perceived by clients accessing the web server.

2. Description of the Related Art

The response time as perceived by clients is the most important performance metric of a web server. Accurate measurements of response time are essential for monitoring service level agreements, client satisfaction, provisioning, and etc. Present methods for estimating or measuring the client perceived response time of the web server can be divided into two categories:
1. Application layer based methodologies; and
2. Transmission control protocol/Internet protocol (TCP/IP) or network layer based methodologies.

These two categories are distinguished from each other on the basis of the networking stack where the estimation or measurement of the response time is performed. At present, these two methodologies are disconnected, creating a need to combine the two distinct approaches to create a solution to estimate client perceived response time of a web server.

Main differences between techniques based on the application and network layers are best explained by the following examples:
1. The active probing method used by Keynote Systems, Inc., described in their “WebEffective Positioning Paper” (Keynote) is a prime example of an application layer based measurement of client perceived response time. Keynote deploys a large number of client computing devices or machines, which are connected to a number of Internet Service Providers (ISPs) and are geographically dispersed throughout the world. These machines periodically access a targeted web application and measure its response time. The response times measured by these dispersed client machines are collected at a central location and distributed to those parties interested in such measurements. A similar approach is taken by vendors like Gomez, Inc., http://www.gomez.com/ (Gomez) and Magnim Networks, Inc., http://www.magnimnetworks.com/network.shtml.
2. In contrast to active probing, a passive probing method involves instrumentation of web pages with a code written in scripting languages such as the JavaScript™. Once this code is downloaded along with instrumented web pages in the Internet browser, such as Microsoft Explorer and Netscape Navigator, the host machine using the code keeps track of the time taken to download the web pages and reports this time back to the web server. This approach is used by Hewlet Packard (HP) OpenView Suite and IBM Web Tracker Product.
Note that in active, as well as in passive probing methods, a bulk of the estimation/measurement task is performed on the client side, utilizing clients' processors.
3. Other present methods to estimate/measure client perceived response time are based on network layer information. In general, such techniques would collect packet traces, i.e., details of packets going to and from the web server. From these details, an attempt is made to infer client perceived response time. For example, this technique is used by the NetQoS Inc. product SuperAgent, which looks into the header information of TCP packets and estimates many factors, such as network round trip time and connection time, which influences the client perceived response time.
4. A similar approach is used by Fu, Cherkasova, Tang, and Vahdat from HP Labs in their paper “EtE: Passive End-to-End Internet Service Performance Monitoring” presented at USENIX 2002 conference. Their approach goes further than NetQoS Inc.'s by examining not only the headers of the TCP packets, but also their contents and by stitching together different factors such as the network round trip time and the connection time to estimate the client perceived response time.
Note that, unlike in the application layer based methods, most of the work in network layer based methods is performed on the web server side by the web server processors.

Both application and network layer based approaches suffer from significant drawbacks, as follows:
1. It is often impossible to replicate a client distribution by an active probing application layer based methods such as used by Keynote and Gomez.
2. The scripting method used by OpenView Suite and Web Tracker requires special instrumentation of web pages.
3. Network layer based methods must deal with a large amount of TCP/IP packet data and therefore require large amounts of processing power. NetQoS uses a dedicated hardware machine attached to a local router/switch port. The EtE technique from HP Labs does not work on encrypted pages since it depends on looking at the contents of TCP packets.
4. It is often impossible to slice clients into small categories, based on different attributes such as geographical location, web page browsed, round-trip time to the web server, and to find response time for clients in each of the categories.

It is therefore an object of the present invention to combine methodologies based on an application and network layers and to propose a novel solution for estimating the client perceived response time of a web server.

### SUMMARY OF THE INVENTION

The present invention estimates/measures client perceived response time by using information available at both application and network layers. The invention avoids the disadvantages of the existing methods such as a need to instrument web pages and have geographically dispersed clients. The invention ties together the information available at the application and network layers by using analytical methods and certain heuristics applied to the web pages. The invention does not require cooperation of the clients as all processing and measurements are performed on the web server devices. Furthermore, the inventive method does not require any changes to the content served by the web server devices. The inventive method is equally well suited for measurements and estimates for the clients sliced into smaller categories, which may be based on different attributes such as geographical location, browsed web pages, etc.

The present invention is a method of estimating a perceived response time of at least one web server computing device to one or more client computing devices connected to the web server via a network. The method comprises the steps of generating and placing a session identifier (ID) as a correlation tag in each of a plurality of requests sent by the client to the web server, wherein said correlation tags identify said requests; generating and placing a connection identifier (ID) as a correlation tag in each communication packet sent between the client and the web server; combining said plurality of requests and said communication packets into a metric, wherein said each request and communication packet corresponding to a single event is identified; and estimating client perceived response time of at least one web server computing device to a request by one or more client computing devices connected to the web server via a network.

### BRIEF DESCRIPTION OF THE DRAWINGS

The foregoing and other objects, aspects, and advantages of the present invention will be better understood from the following detailed description of preferred embodiments of the invention with reference to the accompanying drawings that include the following:

FIG. 1 is a block diagram of an embodiment of the present invention;

FIG. 2a is a flow diagram illustrating inventive data extraction at the network layer according to the present invention;

FIG. 2b is a flow diagram illustrating network packet processing according to the present invention;

FIG. 3a is a flow diagram illustrating data extraction at the application layer according to the present invention;

FIG. 3b is a flow diagram illustrating HTTP request processing according to the present invention;

FIG. 4 is a flow diagram illustrating an analytical model used in accordance with the present invention for calculating the response time; and

FIG. 5 is a flow diagram illustrating an example of the analytical model used according to the present invention for calculating the response time.

### DETAILED DESCRIPTION OF THE PREFERRED EMBODIMENT

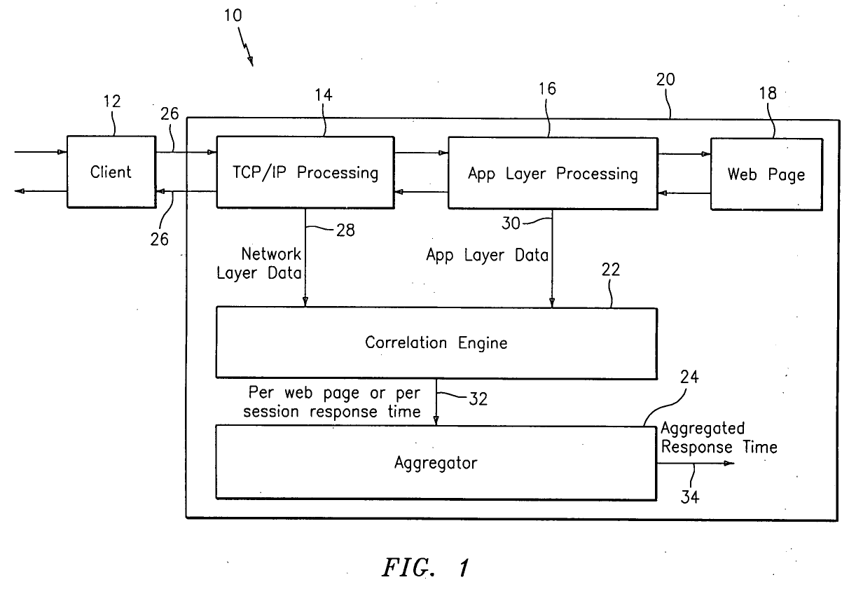

FIG. 1 illustrates a procedural sequence 10 obeyed by a family of algorithms utilized by the present invention, for every web page downloaded from the web server or for every web session conducted with the web server by a client. It is left up to the discretion of the web server administrator whether the inventive method will be used to estimate response time for each web page downloaded or for each web session conducted.

When a client computing device 12 requests to download a web page 18 residing on a web server computing device 20, the client 12 sends a hyper text transfer protocol (HTTP) request to the web server 20, typically over a transmission control protocol/Internet protocol (TCP/IP) network. In order to send the HTTP request, the client 12 first opens one or more TCP/IP connections to the web server 20, if such connection is not already open. Once a connection between the client 12 and the web server 20 is established, the client 12 encapsulates the HTTP request in one or more TCP/IP packets, which are sent across the TCP/IP network 26 to the web server 20.

At the web server 20, the TCP/IP packets sent by the client 12 are processed by the network processing layer 14. The HTTP request contained in these packets is passed to the application layer processing module 16, which interprets the HTTP request and obtains the requested web page 18. On the web server 20, the web page 18 is encapsulated in the TCP/IP packets by the network layer processing 14 and TCP/IP packets are sent to the client 12. Client 12 reconstitutes the sent web page on its side by processing the packets sent across the TCP/IP network 26 by the web server 20.

The data in the application layer is collected on a per HTTP request basis and data in the TCP/IP layer is collected on a per TCP/IP packet basis. Both the TCP/IP or networking layer data 28 and the application layer processing data 30 is collected and forwarded to a correlation engine 22.

The raw data streams collected by the networking and application layers has two main problems:
First, the order of data entries in the network layer raw data stream may be different from the order of data entries in the raw application layer data stream.
Second, the data entries corresponding to each web page or web session may not be consecutive to each other in either the network layer or the application layer raw data stream.

To measure the response time both of these problems need to be resolved: data entries in the networking and application layers that correspond to each other and belong to the same HTTP request need to be identified. Second, the raw data streams from the networking and application layers need to be examined and all data entries belonging to the same web page or the same web session need to be collected.

The present invention solves the first of the above-presented problems by correlating data 28 and 30 collected by the networking and application layers by using correlation tags. The correlation tags are unique to an HTTP request and tag data at both layers. The correlation engine 22 subsequently uses a splicing algorithm to take parts of the data streams that belong to the same web page 18 or the same web session and process these parts together, to compute the response time for a web session or for a web page 18 from a correlated set of networking and application layer information 28 and 30. The response time data 32 is sent to an aggregator 24, which further processes response time data 32 coming from the correlation engine to produce reports 34 on client perceived response time as per administrative settings. For example, administrator may want a report of response time as perceived by the clients coming from a set of IP addresses or visiting certain web pages or conducting certain web sessions, e.g., how much time it is taking to login to the site, how much time is a search on the site taking, etc.

The inventive method includes the following procedures:

Correlation Tags

The present invention utilizes correlation tags present in networking and application layer data 28 and 30 to correlate the data corresponding to a single HTTP request and further to correlate data corresponding to a single web session or web page 18 download. The correlation tags are entries in the web log and network layer log that identify an HTTP request. These tags can be written or set by using the same mechanisms as are used to write web and network logs. The following are some of the possibilities for generating the correlation tags:
By using time stamps in conjunction with the client 12 IP address and/or port number. This minimal information is present in a typical web log and can be easily generated at the network layer.
By passing the tags such as session keys and cookies identifying a web page or a web session to the network layer. In this particular method, the web server kernel is modified so that it can identify tags passed to it by the application layer. These tags are then appended to the network layer data 28 sent to the correlation engine 22.
   Data Collection at the Network Layer

The extent of data collected at the network layer 28 depends on the specific restrictions placed by an operating environment of the web server hardware 20, for example:
Performance data for each TCP connection, which is gathered either by modifying the web server 20 operating system or by using a TCP/IP sniffer that observes the traffic passing back and forth between the web server 20 and clients 12 over the network connection 26. A sniffer observes the TCP/IP packets going back and forth between the web server and the client devices by tapping the physical connection through which network traffic to and from the web server flows. One location to observe the traffic, going to and from a web server, is the router/switch that connects the web server to the network. This router can be tapped and all packets flowing back and forth from the web server can be observed. The software tools for observing such packets are commonly available, for example the TCP dump utility in Linux.
The collected performance data includes round-trip time and packet loss rate for each TCP connection between the web server 20 and clients 12. Data 28-30 may also include metrics such as the number of TCP/IP coarse-grain timeouts, TCP connection idle time, TCP connection termination method, etc. for each TCP/IP connection. Such information is usually present in an operating system kernel and can be easily obtained by instrumenting the operating system kernel. While information regarding the number of TCP coarse-grain timeouts, TCP connection idle time, TCP connection termination method, etc., is present in the kernel, it is not readily available for use. By adding counters and gauges that measure/estimate different quantities mentioned above, and by making these counters and gauges available to a user, information relevant for the present purpose can be gathered. One way to add counters and gauges is to modify the kernel and make these statistics available through added system calls. Another way to make this information available is to log it in a file.
In addition to collecting the network layer data 28 indicated above, time-stamps of several special packets, sent while a TCP/IP connection is established, may also be collected. These special packets include packets sent during the establishment of the TCP/IP connection, for example by the first TCP/IP packet sent from the client 12 with a payload, the first TCP/IP packet sent from the web server 20 with a payload, packets sent just before and after an idle period on the TCP/IP connection, and so forth.

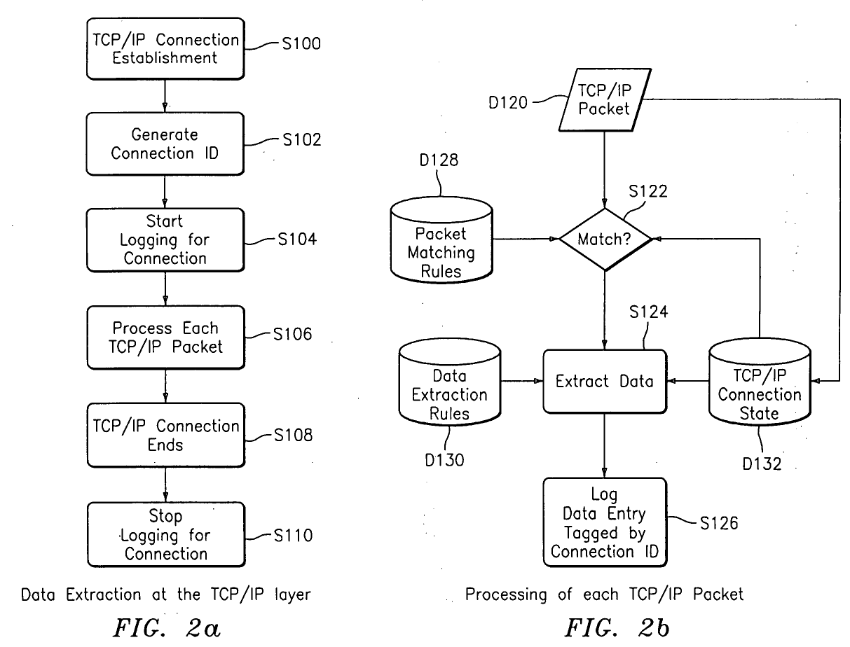

FIG. 2a illustrates the step of data extraction at the network layer. First, a network connection is established at step S100. A connection identifier (ID) is established in step S102. Recordation or logging for the connection through which the TCP/IP packets are sent and received is initiated at step S104. Each logged TCP/IP packet is processed in step S106; this processing will be described below with reference to FIG. 2b. Any termination of the network connection is detected in step S108, after which, the connection logging started in step S104 is terminated at step S110.

FIG. 2b illustrates the network packet processing of step S106 (FIG. 2a). The TCP/IP packet D120 is evaluated in step S122 by being compared with packet matching rules retrieved from a database D128. At the same time the TCP/IP connection state in the database D132 is updated with the TCP/IP packet information. The packet matching rules may require information from a TCP/IP packet D120 and from the TCP/IP connection database D132. An example of the TCP/IP packet information is the settings of SYN/ACK flags, and an example of the connection information is the beginning of a coarse-grain timeout. If there is a match in step S122, i.e., the TCP/IP packet and connection information matches with the rules in D128, then the data is extracted from the TCP/IP packet in step S124 according to the data extraction rules retrieved from the database D130. In step S126, the extracted data is tagged by a connection identifier and is recorded or logged.

Data Collection at the Application Layer

The extent of data collected at the application layer 30 depends on the specific restrictions placed by an operating environment of the web server hardware 20, for example:
A web log of a web server contains one entry for each HTTP request made by a client. Typically that entry includes data identifying a client, e.g., IP address and/or port number, session ids, cookies, identifier and time of a served web page 18, number of bytes transferred, and the HTTP status of the web page 18 service request. In addition, information regarding the composition of the web page is also collected. An example of such information is the number of embedded documents in a given web page 18, and the size and order of embedded documents.
In addition to collecting the application layer data indicated above, the application layer may collect data on the web server response time including the time it takes for a web server 20 to respond to a request for a web page 18.

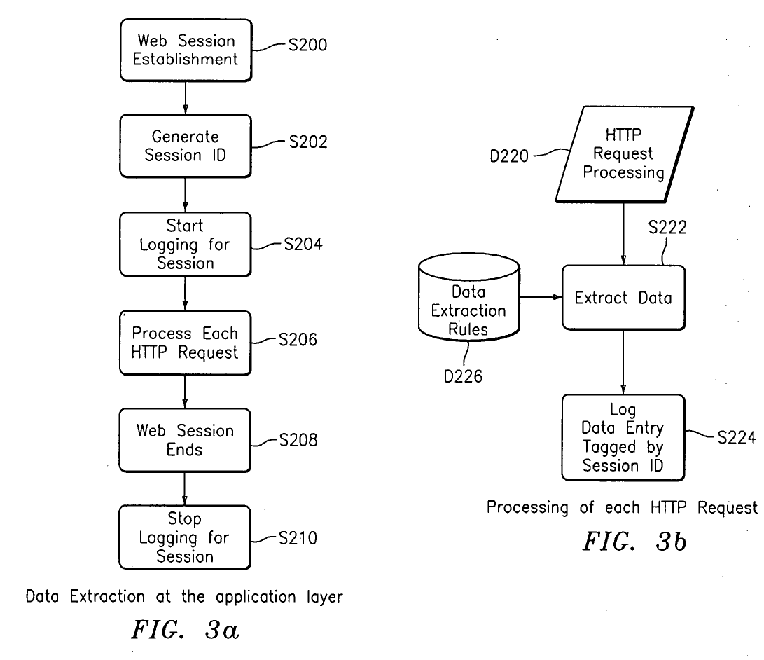

FIG. 3a illustrates the step of data extraction at the application layer. First, a web session is established at step S200. A session identifier (ID) is established in step S202. Recordation or logging for the session is initiated at step S204. Each HTTP request is processed in step S206; this processing will be described below with reference to FIG. 3b. Any termination of the web session is detected in step S208, after which, the connection session logging started in step S204 is terminated at step S210.

FIG. 3b illustrates the HTTP request processing of step S206 (FIG. 3a). The HTTP request D220 is processed in step S222 by extracting the data from the request header according to rules retrieved from a database D226. In step S224, the extracted data is tagged by with a session identifier and is recorded or logged.

Correlation Engine

The correlation engine uses correlation tags present in data 28-30 from both layers to identify information corresponding to a particular web page 18 download or a particular web session. Note that data that corresponds to a particular web page 18 download or a particular web session would have similar tags. Once the data corresponding to a web page download or a web session is identified, a splicing algorithm is used to compute the response time. The method used for splicing the time-tagged entries depends on the extent and accuracy of collection data, for example:
An algorithm may take as an input the average round-trip time and packet loss rate at TCP/IP connections to a client 12 (FIG. 1) and the composition of the downloaded web page(s) 18 (FIG. 1). The composition includes the size and order of embedded objects within a web page 18. The algorithm then uses an analytical model to compute the response time. This analytical model essentially recreates dynamics between the TCP/IP flow and HTTP request/response stream to calculate the response time. One example of such an analytical algorithm is the affine model which models service time of one HTTP request as N*T+P, where T is round-trip time between client and web server and N and P are constants that depend on a page composition and a packet loss rate. One way to obtain these constants is by simulations. Another way to obtain these constants is to make simplifications, such as those used by CSA2000, to calculate the data transfer rate of a TCP/IP connection.
A more elaborate algorithm recreates the flow of the web content between the client and the web server by using timestamps of some marker TCP/IP packets. Timestamps of these marker packets identify the time when a request for specific content from a specific client comes to the web server and when the web server finishes serving the request. Since application data is not collected at the network layer, marker packets need to be correlated with the specific content by using the timestamps and other correlation tags collected from the application layer. Once the two marker packets, one identifying the start of a request service and another identifying the end of the request service are identified, the response time is obtained by subtracting the timestamps of these two packets. According to the administrative setting additional time may be added to the response time to compensate for the time taken by the TCP/IP connection setup, time taken by the request to come to the web server 20, and time taken by the response to get back to the client 12.

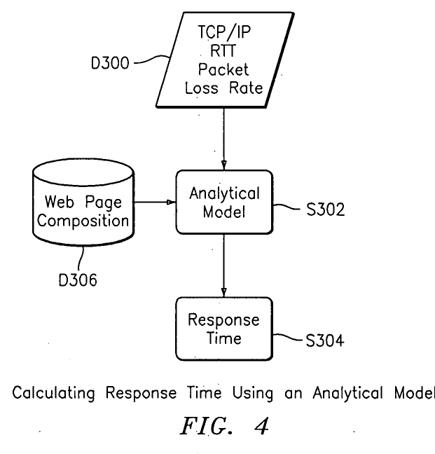

FIG. 4 illustrates the analytical model used by the present invention for calculating the response time. In step S302 the inventive analytical model analyzes the TCP/IP round trip time (RTT) and packet loss rate (D300) along with the web page composition information, retrieved from the database D306 to calculate the response time in step S304.

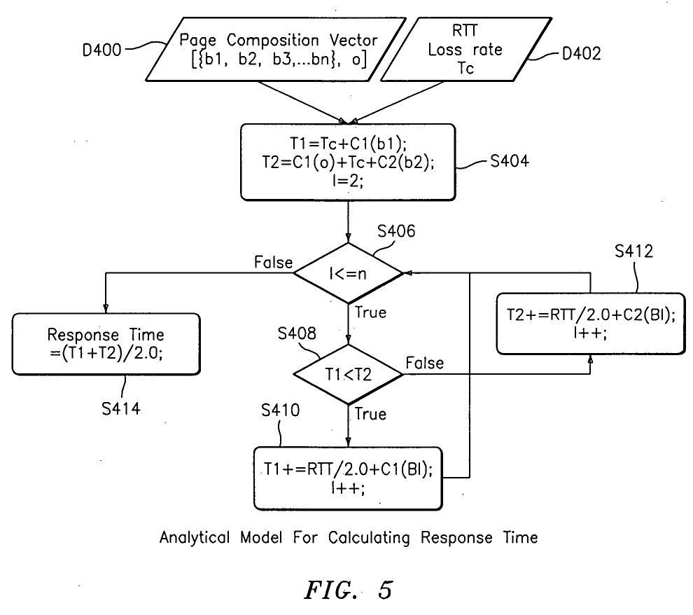

More specifically, FIG. 5 illustrates an example of the analytical model used by the present invention for calculating the response time. Two response times, a T1 and T2 are initialized in step S404 by retrieving the page composition vector from memory or a database D400 and the TCP/IP round trip time RTT, packet loss rate, and average connection time Tc from memory or a database D402. The page composition vector is composed of {b1, b2, bn} and o, where b1, b2, . . . , bn are the sizes of different components of a web page including the container or the top level page. The sizes are specified in a sequence that is typical of web page download, n is the number of components of a web page including the container page, and o is the byte offset on the container page where the first component of the web page is embedded. The time T1 is initialized to be T1=Tc+C1(b1), where C1 is the state of first TCP connection and C1 (b1) gives the value of the time it takes to download the container page of size b1 on the first TCP connection. The time T2 is initialized to be T2=C1(o)+Tc+C2(b2), where C1(o) is the time it takes to download o bytes on the first TCP/IP connection, Tc is the time it takes to establish the second TCP/IP connection, and C2(b2) is the time it takes to download b2 bytes on the second TCP connection. Time to download a fixed number of bytes on a given TCP connection can be calculated by using an analytical model such as the one given in CSA2000. Additionally, step S404 sets the loop counter I.

In step S406, a determination is made whether the loop counter I is less than or equal to the value n described above. If I is greater than n, the processing concludes in step S414, where response time is determined by averaging T1 and T2 as follows: (T1+T2)/2.

Otherwise, in step S408, it is determined whether T1 is smaller than T2. If T1 is smaller, then in step S410 T1 is incremented by the half of RTT and C1(BI), where C1(BI) is the time it takes to download BI bits on the first TCP/IP connection, as follows: T1=T1+(RTT/2)+C1(BI); the counter I is incremented by 1; and the processing returns to and continues in step S406.

If, however, in step S408 it was determined that T1 is not smaller than T2, then in step S412, it is T2 that is incremented by the half of RTT and C2(BI), where C2(BI) is the time it takes to download BI bits on the second TCP/IP connection, as follows: T2=T2+(RTT/2)+C2 (BI); the counter I is incremented by 1; and the processing returns to and continues in step S406.

While the invention has been shown and described with reference to certain preferred embodiments thereof, it will be understood by those skilled in the art that various changes in form and details may be made therein without departing from the spirit and scope of the invention as defined by the appended claims.

1. A method of computing response time of a web server comprising the steps of:
placing a plurality of correlation tags in data at networking and application layers, wherein said tags allow for later identification of said data;
collecting said data from said layers, wherein said data corresponds to a single event;
combining said data from networking and application layers into a metric, wherein said data corresponding to a single web event is identified; and
calculating client perceived response time.

2. The method of claim 1, wherein said event is selected from one of a web page download and a web session.

3. The method of claim 1, wherein said calculating step is performed using analytical models of response time.

4. A method of estimating of a perceived response time of at least one web server computing device to one or more client computing devices connected to the at least one web server device via a network, the method comprising the steps of:
generating and placing a session identifier (ID) as a correlation tag in each of a plurality of requests sent by a client to a web server device, wherein said correlation tags identify said requests;
generating and placing a connection identifier (ID) as a correlation tag in each communication packet sent between the client and the web server device;
combining said plurality of requests and said communication packets into a metric, wherein said each request and communication packet corresponding to a single event is identified; and
estimating client perceived response time of at least one web server computing device to a request by one or more client computing devices connected to the web server device via a network.

5. The method of claim 4, wherein the network is the Internet.

6. The method of claim 4, wherein said step of generating and placing the session ID further comprises a step of establishing a web session between the client and the web server device.

7. The method of claim 4, further comprising a step of logging each web session between the client and the web server device.

8. The method of claim 4, wherein said step of generating and placing a connection ID further comprises a step of establishing a network connection between the client and the web server device.

9. The method of claim 4, further comprising a step of logging said each communication packet sent between the client and the web server.

10. The method of claim 4, further comprising a step of grouping all of said plurality of requests and said communication packets corresponding to a single event.

11. The method of claim 4, wherein said estimating step further comprises the steps of
a) retrieving a page composition vector and TCP/IP round trip time (RTT), packet loss rate, and average connection time Tc;
b) calculating time T1=Tc+C1(b1) and time T2=C1(o)+Tc+C2(b2) and setting a loop counter;
c) averaging T1 and T2 by (T1+T2)/2 and terminating processing if the loop counter is less than or equal to the value n;
otherwise, if T1 is smaller than T2, T1 is set to T1+(RTT/2)+C1(BI), and if T1 is not smaller than T2, T2 is set to T2+(RTT/2)+C2(BI); and
d) incrementing the loop counter and repeating step c,
wherein the page composition vector is composed of {b1, b2, . . . bn} and o,
bi, where i is an number 1,2, . . . , being the size of the i-th component of the web page,
n being the number of components,
o being the offset at which first component is embedded in a container page,
C1(y) being the time it takes to download y bytes on a first TCP/IP connection between the client and the web server device, and
C2(y) being the time it takes to download y bytes on a second TCP/IP connection between the client and web server device.

12. An apparatus for estimating a perceived client response time of at least one web server computing device to one or more client computing devices connected to the at least one web server via a network, the method comprising:
a means for generating and placing a session identifier (ID) as a correlation tag in each of a plurality of requests sent by the one or more client computing devices to the at least one web server, wherein said correlation tags identify said requests;
a means for generating and placing a connection identifier (ID) as a correlation tag in each communication packet sent between the one or more client computing devices and the at least one web server;
a means for combining said plurality of requests and said communication packets into a metric, wherein said each request and communication packet corresponding to a single event is identified; and
a means for estimating the perceived client response time of at least one web server computing device to a request by one or more client computing devices connected to the web server via a network.

13. A computer program device readable by a machine, tangibly embodying a program of instructions executable by the machine to perform method steps for an apparatus for estimating a perceived client response time of at least one web server computing device to one or more client computing devices connected to the at least one web server via a network, the method comprising:
a means for generating and placing a session identifier (ID) as a correlation tag in each of a plurality of requests sent by the one or more client computing devices to the at least one web server, wherein said correlation tags identify said requests;
a means for generating and placing a connection identifier (ID) as a correlation tag in each communication packet sent between the one or more client computing devices and the at least one web server;
a means for combining said plurality of requests and said communication packets into a metric, wherein said each request and communication packet corresponding to a single event is identified; and
a means for estimating the perceived client response time of at least one web server computing device to a request by one or more client computing devices connected to the web server via a network.
